(19) United States
(12) Patent Application Publication
(10) Pub. No.: US 2011/0045369 A1
(43) Pub. Date: Feb. 24, 2011

(54) FUEL CELL SYSTEM AND METHOD FOR OPERATING A FUEL CELL SYSTEM

(75) Inventor: Ralf Nuessle, Heidenheim (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/933,722

(22) PCT Filed: Mar. 31, 2009
(86) PCT No.: PCT/EP09/02338

§ 371 Date: Sep. 21, 2010

(30) Foreign Application Priority Data
Apr. 1, 2008 (DE) 10 2008 016 579.4

(51) Int. Cl. H01M 8/04

(52) U.S. Cl. 429/428

(57) ABSTRACT

Fuel cell apparatus with at least one fuel cell (2) having an anode region (4) and a cathode region (3) and being accommodated in a housing (6), wherein a flushing medium for flushing the housing (6) can be introduced into a space (7) of the housing (6) outside the fuel cell (2). According to the invention, a device (16, 17, 18, 19) is provided for discharging the medium mixture contained in the space (7) and containing the flushing medium, which device is connected to the space (7) and to an exhaust line (15, 15a) leading off the cathode region (3) and which device is designed such that the discharge of the medium mixture is coupled in terms of flow technology to the exhaust gas stream flowing in the exhaust line (15, 15a). The invention further relates to a method for the operation of a fuel cell apparatus of this type.

The invention relates to a fuel cell apparatus with at least one fuel cell having an anode region and a cathode region and being accommodated in a housing. A flushing medium for flushing the housing can be introduced into the housing outside the fuel cell. The invention further relates to a method for the operation of a fuel cell apparatus wherein a flushing medium for flushing the housing which accommodates a fuel cell is introduced into the housing outside the fuel cell.

A fuel cell apparatus and a method of this type are known from WO 2005/099017 A2. In this specification ambient air is fed in from the outside as a flushing medium.

In fuel cell systems, the fuel cell or a fuel cell stack comprising several fuel cells is usually accommodated in a housing. On the one hand, this housing protects the fuel cell stack against external influences such as dirt, dust, water etc., while on the other hand it catches any leaks of the fuel cell stack, in particular of the anode, and the hydrogen emissions involved in such leaks and diverts them to a defined location in a controlled manner. This however involves the problem that the leakage of the fuel cell stack can generate gas mixtures within the housing which may be flammable or explosive owing to their composition. In prior art, attempts to avoid this are based on flushing the housing continuously with fresh air fed into the housing from the environment by a fan or ventilator. In this context, the fan of the fuel cell system according to WO 2005/099017 A2 also supplies air to the cathode. Adjacent to the inlet line, a discharge line is provided on the housing, which may for example terminate into a discharge air or exhaust passage. The continuous flushing of the housing with fresh air is meant to ensure that no undesirable hydrogen/air mixture is formed in the housing. This however poses the problem that an additional separate fan has to be provided for implementing the flow through the housing. This fan has to be driven by a motor, which has a negative effect on the overall efficiency of the system while not making any contribution to energy conversion. The fan usually has a limited power and can only deliver a defined, relatively small air flow, which makes continuous operation necessary.

Within the housing, a sensor may further be provided to measure the hydrogen concentration in the housing. If this concentration exceeds a defined limit value, the whole fuel cell system is switched off, as the fan may no longer be able to deliver sufficient air to lower the hydrogen concentration in the housing. Flushing with ambient air also has further disadvantages, because it contains approximately 21% oxygen, which in the end forms a component of the gas mixture which is potentially explosive at a certain hydrogen concentration. In addition, the noise emission of a continuously running fan may be found uncomfortable.

In this context, fuel cell systems are known in which, for example downstream of an air filter unit, a line terminating into the housing branches off the induction section of the compressor for the cathode region of the fuel cell system. This line likewise accommodates a fan which conveys the branched-off air into the housing. The medium which is then discharged from the housing is fed into the induction section for the cathode region upstream of the compressor. The gas mixture of the housing is therefore fed to the compressor, which draws the gas mixture in and feeds it into the cathode section of the fuel cell. The possibly very small proportion of hydrogen which is discharged from the housing in this process is then diluted by the air drawn by the compressor from the environment. The gas flow is then compressed and fed to the cathode, where the very small proportion of hydrogen reacts chemically. This is meant to ensure that there is no hydrogen emission into the external environment. The explanations given above apply to the fan in this branch line; here, too, the fan operates continuously at a fixed point and the housing is flushed continuously.

The present invention is based on the problem of creating a fuel cell apparatus and a method for the operation of a fuel cell apparatus, wherein the housing can be flushed efficiently outside the fuel cell without any unpleasant noise emissions being caused by a separately provided fan, and wherein moreover no undesirable fuel/oxidant mixture is created by the flushing process.

This problem is solved by a fuel cell apparatus with the features of claim 1 and by a method with the features of claim 22.

A fuel cell apparatus according to the invention comprises at least one fuel cell having an anode region and a cathode region and being accommodated in a housing. A flushing medium for flushing the housing can be introduced into the housing into a space outside the fuel cell. The fuel cell apparatus comprises a device for discharging the medium mixture contained in the space and containing the flushing medium, this device being connected to the interior of the housing and to an exhaust line leading off the cathode region. In addition, the device is designed such that, as the medium mixture is discharged from the space of the housing, the space and therefore the medium mixture are coupled to the exhaust gas stream in the exhaust line in terms of flow technology. This device can therefore provide a component by means of which the flushing process can be simplified without requiring a quasi-active component such as a fan and by means of which the formation of undesirable medium mixtures, in particular undesirable hydrogen/air mixtures, in the space can be prevented.

The device is therefore a virtually passively acting unit, resulting in a higher reliability than provided by actively acting units. The device is designed such that it utilises the contexts of flow technology for discharging or extracting the medium mixture in the space. There is therefore no need for an active component such as a fan for the complete removal of the mixture from the housing.

The flushing medium is preferably fresh air drawn in from the environment.

The device is preferably designed such that the exhaust gas stream forms a propulsion jet by means of which the medium mixture can be drawn from the space automatically.

The device is in particular designed as a pump, preferably as a jet pump. This is a particularly simple structure and represents an extremely reliable concept. A jet pump of this type is particularly effective in converting the contexts of flow technology with respect to the automatic extraction of the medium mixture from the space together with the flowing exhaust gas stream.

The device, in particular the jet pump, preferably has a narrowing with a flow cross-section which is reduced compared to the flow cross-section upstream and downstream of the narrowing. With respect to its narrowing, the device is designed such that the flow cross-section increases both upstream and downstream of the narrowing. In terms of flow technology, this can ensure a jet effect, for example as in a Laval nozzle. Owing to the flow of the exhaust gas stream through this narrowing, this narrowing can be coupled to the space in a particularly expedient manner in terms of flow technology for extracting the medium mixture from the space.

In this context, it is in particular provided that the device comprises a line terminating into the space, which branches off this narrowing.

The opening of the line into the space is in particular oriented towards the side. In this context, the line can terminate into the space quasi-laterally, in particular horizontally.

It may also be provided that the opening of the line into the space is oriented towards the top, extending in particular vertically upwards (with respect to the direction of the force of gravity). This second solution in particular makes it possible to extract the fuel, in particular hydrogen or a hydrogen-containing gas, settling in an upward direction in the housing in a particularly suitable manner, thereby flushing the housing very effectively.

The device for discharging the medium mixture from the space, in particular the line of this device, preferably terminates into the space above the fuel cell (with respect to the direction of the force of gravity). This design, too, can take account of the fact that the fuel settles in an upward direction in the space, so that any upward-settling fuel which may be discharged from the fuel cell owing to leakage can be flushed out in a particularly effective way. The housing preferably comprises an opening for the supply of the flushing medium, which is formed below the fuel cell (with respect to the direction of the force of gravity). This development likewise promotes the flushing effect, as the fuel, as a result of the inflow from below or at a level below the fuel cell, can be driven upwards and there flushed or discharged from the housing accordingly. It may further be provided that the housing has an opening for the supply of flushing medium which is formed above the fuel cell (with respect to the direction of the force of gravity).

The opening may expediently be closable by a closing element which is in particular controllable by electronic means. As a result of this development, the opening is not open permanently, but can be opened or closed as required. It is in particular provided that the closing or opening position of the closing element is determined by the fuel concentration in the space of the housing outside the fuel cell.

This fuel concentration can preferably be determined by means of a device for determining this concentration, in particular a suitable sensor system. This sensor system is preferably located in the housing outside the fuel cell. With respect to its vertical level, this sensor system is in particular located above the fuel cell (with respect to the direction of the force of gravity), preferably adjacent to the top cover of the housing.

The device is in particular completely accommodated in the housing. This results in a compact construction.

Upstream of the device for discharging the medium mixture from the housing, a bypass line for bypassing this device, which branches off the exhaust line of the cathode region, is in particular provided. This results in a bypass design which allows the exhaust gas stream to be diverted depending on the situation or on requirements. The proportion of the exhaust gas stream which is required for the implementation of the flow technology principle can therefore be metered very precisely. Depending on operating phases, either the whole of the exhaust gas stream can be directed through the device, or only a part thereof may be directed through the device, or the whole of the exhaust gas stream may be directed through the bypass line.

The proportions of the exhaust gas stream which flow through the device for discharging the medium mixture and through the bypass line are in particular adjustable. These proportions of the exhaust gas stream are preferably made dependent on a fuel concentration in the space of the housing. Particularly preferable in this context is a provision that the fuel cell apparatus comprises an adjusting element which is capable of changing the flow cross-sections of the exhaust line on the one hand and the flow cross-sections of the bypass line on the other hand. This adjusting element is preferably controllable electronically, and its position can preferably be changed accordingly. This, too, may be determined by the fuel concentration in the space where the medium mixture is accommodated. The adjusting element is in particular provided at the branch point between the exhaust line and the bypass line.

The fuel cell apparatus preferably comprises a catalyst through which the medium mixture discharged from the space can be directed. This catalyst can in a preferred way deplete the fuel contained in the medium mixture, thus preventing the discharge of a medium mixture with an undesirably high fuel content. The catalyst is preferably located in the line running between the space and the narrowing of the device for discharging the medium mixture.

The catalyst may obviously be provided at another point in the path between the housing and the environment, the medium mixture being directed along this path.

In a method according to the invention for the operation of a fuel cell apparatus with at least one fuel cell having an anode region and a cathode region and being accommodated in a housing, a flushing medium for flushing the space of the housing is introduced into the housing outside the fuel cell. An exhaust gas stream flowing in an exhaust line of the cathode region is, in terms of flow technology, coupled to the space by a device in such a way that that the medium mixture contained in the space and containing the flushing medium is, in particular automatically, extracted from the space. Owing to this process, it is no longer necessary to provide an active element, such as a fan, for flushing and discharging the medium mixture. Based on principles of flow technology, the method according to the invention allows the implementation of a passive process, so that the number of components can be reduced and the efficiency of the fuel cell apparatus is not affected by such active components.

The device for discharging the medium mixture from the space is preferably enabled to extract the medium mixture in dependence on a fuel concentration in the space. As a result, the device does not have to be continuously active, but is used only in specific operating phases as required.

The space of the housing with the medium mixture is in particular flushed with fresh air.

Advantageous further developments of the fuel cell apparatus according to the invention and in particular the operation and the combination of substantive features should also be considered as advantageous further developments of the method according to the invention.

According to the invention, the device for discharging the medium mixture, in particular the jet pump, is based not on an “active” but rather on a “passive” concept, resulting in increased reliability. The use of the advantageous jet pump involves only a minimum increase in weight and space requirements compared to a system without any housing ventilation and offers a significant weight and space saving opportunity compared to a system with an auxiliary fan and drive motor. As there is no need for the continuous operation of a fan, such a system with a jet pump is energetically more efficient and therefore surpasses the efficiency of systems known from prior art. The higher pressure drop resulting from the jet pump, which is due to the higher pumping power required, can be counteracted by making the exhaust air or gas stream bypass the jet pump through the bypass line, thus choosing the path of a very low pressure drop in the exhaust air section. The adjusting element, in particular a damper, is if required set to a position in which the exhaust gas stream is directed via the jet pump to draw the medium mixture, in particular the gas mixture, from the housing. As this preferably happens whenever a defined fuel concentration, in particular a defined hydrogen concentration, is detected in the space of the housing containing the medium mixture, and as the exhaust air stream is directed through the bypass line for the rest of the time, resulting in a lower pressure drop and a lower pumping effort of the compressor, this arrangement is highly efficient, the short-term energetic effort involved being very low. The damper, which is preferably disposed in the exhaust gas stream, further offers the opportunity of at least partially increasing the pressure level in the fuel cell stack, which, although it may be less efficient overall, allows the power or the power density of the fuel cell to be increased by the increased pressure in the cathode region. This applies in particular to the use of the fuel cell apparatus at altitudes with lower pressures. It further means that, even if the jet pump is used without the bypass line, losses in efficiency are relatively low, because the increased pumping effort at a higher pressure drop, i.e. when the exhaust gas stream is directed via the jet pump, can be compensated at least partially by the increased pressure in the cathode region and by the higher efficiency of the fuel cell stack provided thereby.

The fuel cell apparatus may alternatively be designed such that the exhaust gas stream generated in the cathode region and the exhaust gas stream generated in the anode region are directed via the jet pump, and the advantageously provided catalyst element does not necessarily have to be located in the suction line connecting the space containing the medium mixture to the device for discharging the medium mixture, but it can be provided at any other point in the exhaust air train where the exhaust air of the cathode, the flushed fuel of the anode and the caught leakages are jointly directed via such a catalyst element.

This also allows for the implementation of a safety philosophy in that the adjusting element in the exhaust line of the cathode region is in its de-energised state set to a position in which the exhaust gas stream of the cathode region always flows through the device for discharging the medium mixture from the housing in this state. This would ensure that the medium mixture is extracted from the housing even if the actuator for setting the adjusting element, in particular the damper, is defective.

Embodiments of the invention are explained in greater detail below with reference to the diagrammatic drawings, of which:

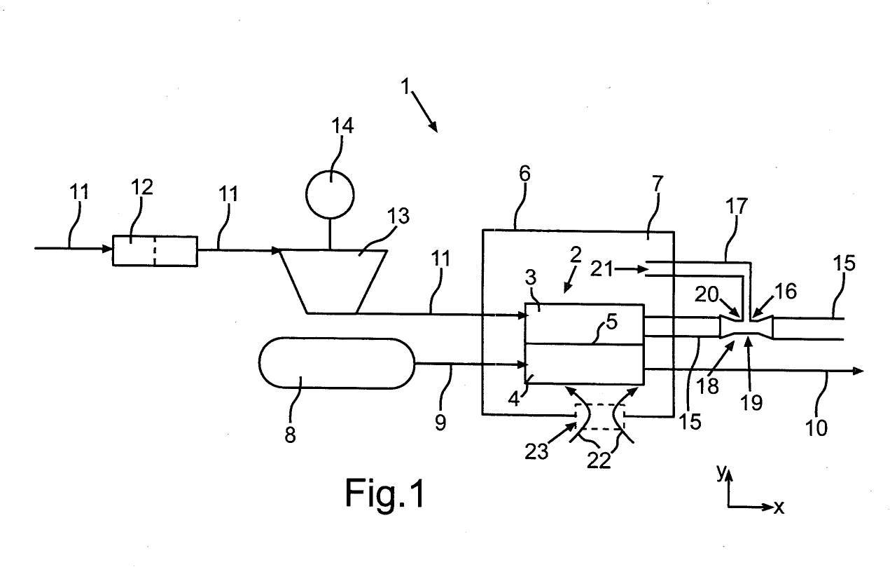

FIG. 1 shows a first embodiment of a fuel cell apparatus according to the invention;

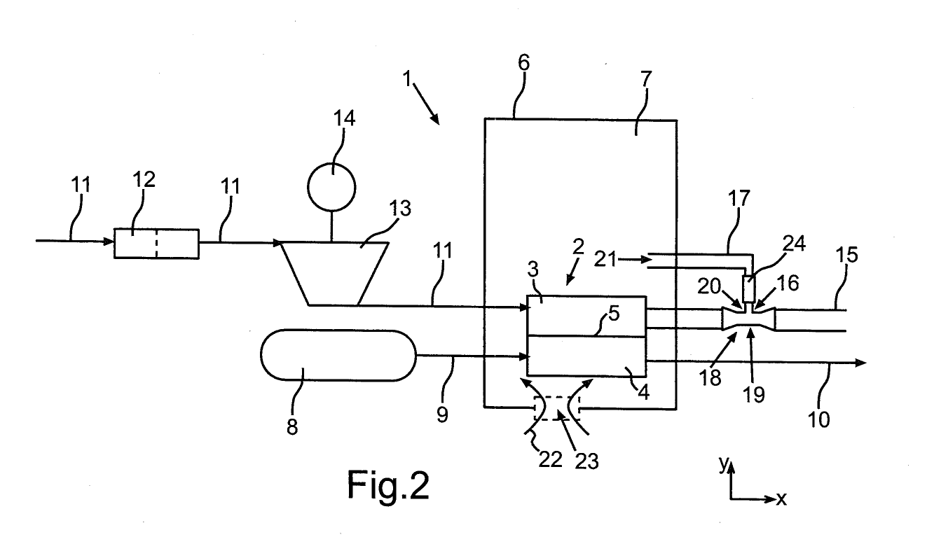

FIG. 2 shows a second embodiment of a fuel cell apparatus according to the invention;

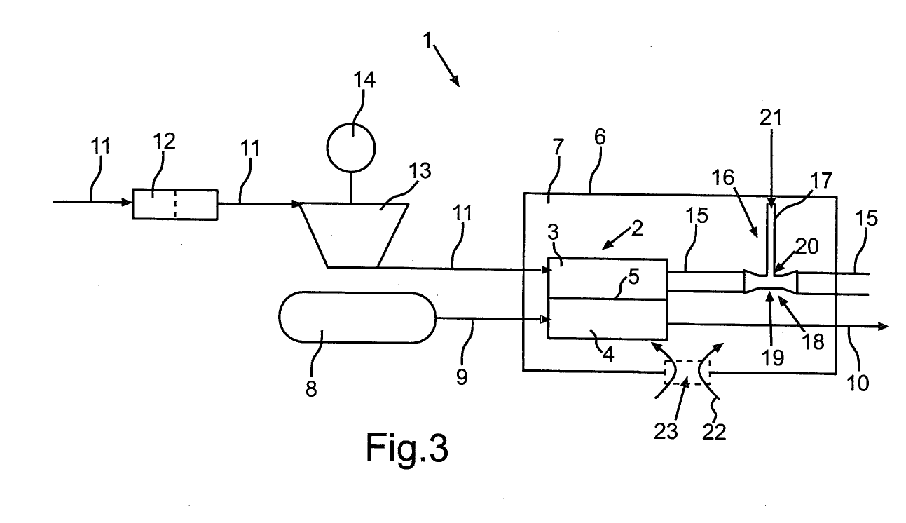

FIG. 3 shows a third embodiment of a fuel cell apparatus according to the invention;

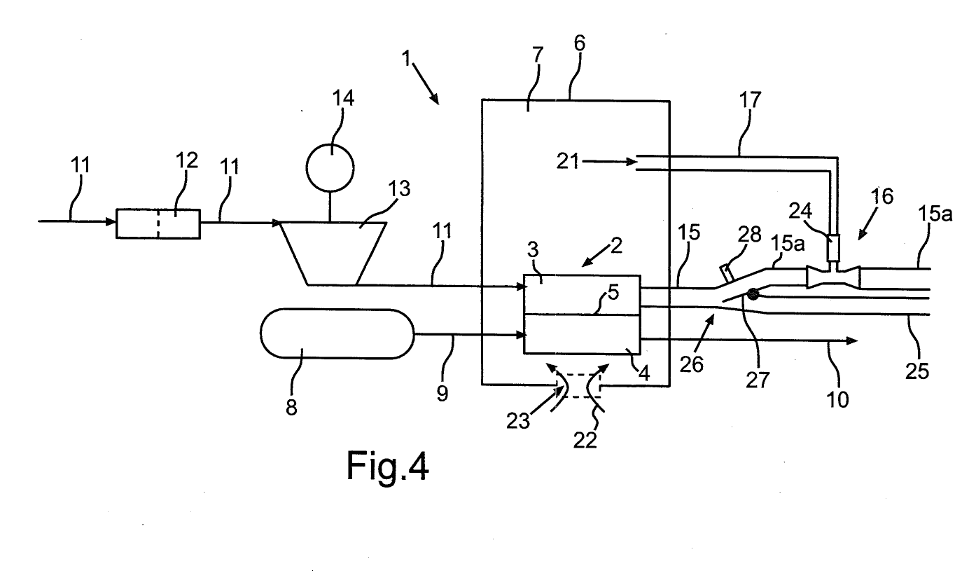

FIG. 4 shows a fourth embodiment of a fuel cell apparatus according to the invention;

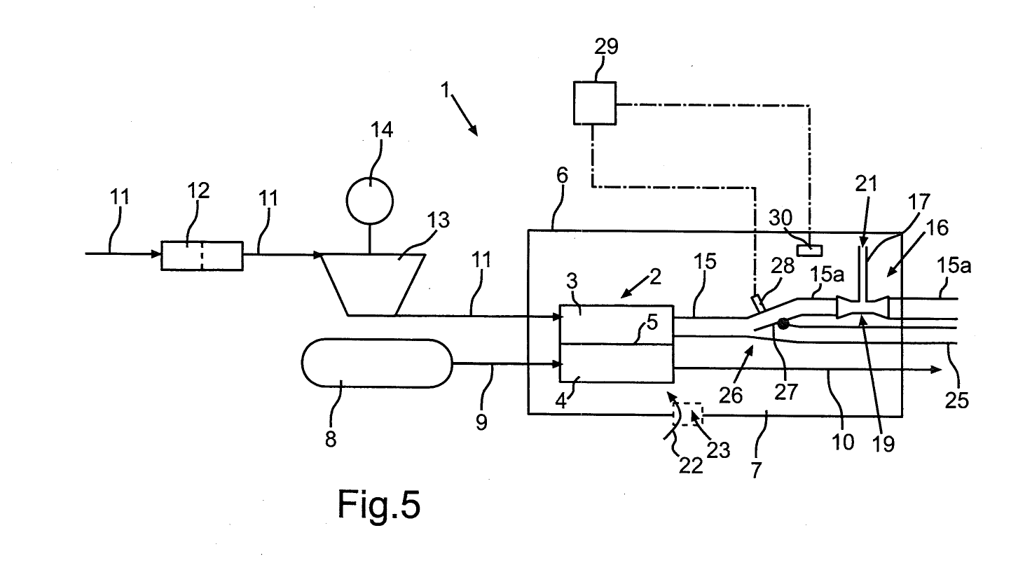

FIG. 5 shows a fifth embodiment of a fuel cell apparatus according to the invention;

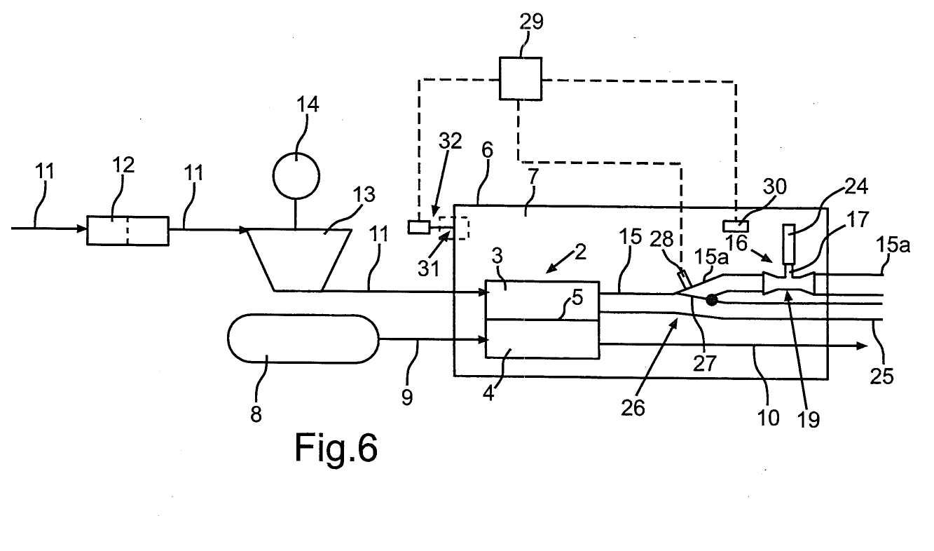

FIG. 6 shows a sixth embodiment of a fuel cell apparatus according to the invention; and

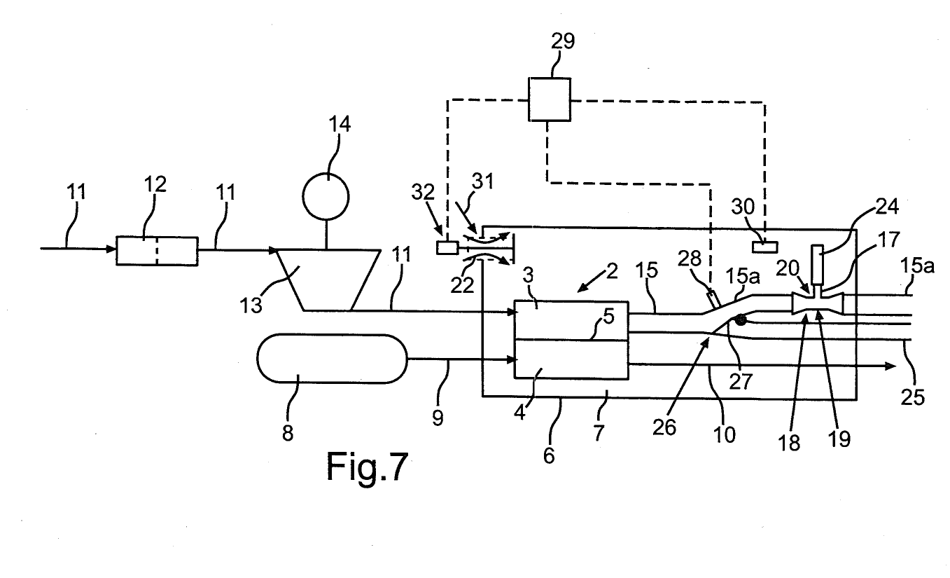

FIG. 7 shows a seventh embodiment of a fuel cell apparatus according to the invention.

Identical elements or elements of identical function are identified by the same reference numbers in the figures.

FIG. 1 shows a first embodiment of a fuel cell apparatus 1 which is designed as a mobile fuel cell system and installed into a vehicle. The fuel cell apparatus 1 comprises a fuel cell 2 having a cathode region 3 and an anode region 4. The cathode region 3 and the anode region 4 are separated from each other by a PEM (proton exchange membrane) 5. The fuel cell 2 of the illustrated embodiment is designed as a PEM fuel cell. The fuel cell apparatus 1 comprises a fuel cell stack preferably containing a plurality of fuel cells 2. For clarity, only one fuel cell 2 is shown in the illustrated embodiment.

The fuel cell 2 is accommodated in a housing 6 which protects the fuel cell 2 against contamination, external influences and damage.

In an interior space 7 of the housing 6, outside the fuel cell 2, fuel may collect during the operation of the fuel cell 2 owing to leakages of the fuel cell 2 or to other processes, and this fuel has to be flushed from the space 7. Fuel, in particular hydrogen or a hydrogen-containing gas, is fed to the anode region 4 via an anode branch. This fuel is stored in a reservoir and fed into the anode region 4 via a supply line 9. The anode exhaust gas can be returned to the anode either completely or partially via a return line and a recirculation device, such as a pump (not shown in the drawing). Any anode exhaust gas generated in the anode region 4 in the operation of the fuel cell 2 is discharged from the anode region 4 via an exhaust line 10, in particular into the environment.

The fuel cell apparatus 1 further comprises a cathode branch with a supply line 11 through which an oxidant or an oxygen-containing gas such as ambient air is fed into the cathode region 3. An air filter 12 connected to or installed into the supply line 11 is provided in the cathode branch. Downstream of the air filter 12, a compressor 13 driven by a motor 14 to convey the oxidant into the cathode region 3 via the supply line 11 is provided.

The fuel cell apparatus 1 and in particular the cathode branch moreover comprises an exhaust line 15 for the discharge of the cathode exhaust gas generated in the cathode region 3 in the operation of the fuel cell 2. This is likewise discharged into the environment. Both the cathode branch and the anode branch can obviously be provided with a recirculation device by means of which the exhaust gas of the cathode region 3 is returned into the supply line 11 and/or the anode exhaust gas is returned into the supply line 9.

The fuel cell apparatus further comprises a device for discharging the medium formed in the space 7, which includes the collected fuel and the flushing medium, from the space 7. In the illustrated embodiment, this device is designed as a jet pump 16. A part element of the jet pump 16 is located in the exhaust line 15 or connected thereto. The jet pump 16 is designed as a passive component. As a result of contexts of flow technology, a suitable design of the jet pump 16 ensures that the medium mixture in the space 7 can be extracted automatically as required in a situation-specific manner. For this purpose, the jet pump 16 is connected to the space 7 via a line 17 on the one hand and to the exhaust line 15 on the other hand. The exhaust gas or exhaust gas stream discharged from the cathode region 3 flows through the exhaust line 15 and thus through the jet pump 16. Owing to contexts of flow technology, the medium mixture can be extracted from the space 7 by means of the exhaust gas stream and the connection between the jet pump 16 and the space 7. This is achieved in a particularly advantageous manner by providing that the device or jet pump 16 includes an element 18 having a narrowing 19. The element 18 is designed such that that it extends in an axial direction and thus in its longitudinal direction and in this context also in the longitudinal direction of the exhaust line 15 while having a varying flow cross-section. In this context, it is provided that the narrowing 19 has a flow cross-section which is smaller than the flow cross-section upstream and down-stream of the narrowing 19. The element 18 of the jet pump 16 therefore has a widened flow cross-section upstream and downstream of the narrowing 19, whereby a principle according to a Laval nozzle can be implemented.

The line 17 terminates at this narrowing 19-cf. termination 20. As FIG. 1 shows, the line 17 branches off a point of the housing 6 which lies above the fuel cell 2 (with respect to the direction of the force of gravity) if viewed vertically (y-direction). This is advantageous, because the fuel flowing from the fuel cell 2 settles in a upward direction (positive y-direction) in the space 7. In the illustrated embodiment, the line 17 is oriented such that it emerges virtually horizontally from the housing 6, so that the opening 21 is oriented virtually laterally, resulting in a lateral extraction from the space 7. The jet pump 16 is located downstream of the fuel cell 2 and connected both to the space 7 and to the exhaust line 15.

To flush the space 7, fresh air 22 is introduced into the housing 6 from the outside or the environment via an opening 23. According to the embodiment of FIG. 1, the opening 23 is formed at a bottom or base of the housing 6 and therefore below the fuel cell (with respect to the direction of the force of gravity) with respect to its vertical position.

The exhaust gas stream flowing from the cathode region 3 into the exhaust line 15 acts as a propulsion jet in the jet pump 16, resulting in an automatic and passive extraction of the medium mixture comprising fresh air 22 and the fuel collected in the space 7 owing to the flow-technological coupling arrangement.

FIG. 1 further shows that the jet pump 16 is located outside the housing 6. In the embodiment of the fuel cell apparatus 1 shown in FIG. 1, a continuous flushing of the housing 6 is implemented. In addition, the medium mixture formed in the space 7 is likewise extracted continuously by the jet pump 16.

The embodiment according to FIG. 2 differs from that of FIG. 1 by the provision of a catalyst 24 through which the medium mixture extracted from the space 7 is made to flow. In FIG. 2, the catalyst 24 is located in the line 17 which connects the space 7 or the housing 6 to the element 18 of the jet pump 16. In the catalyst 24, the hydrogen contained in the fuel/oxidant mixture or in the hydrogen/air mixture is reacted, so that very little, if any, hydrogen can be discharged into the environment.

This catalyst may obviously be located at another point of the flow path of the medium mixture.

FIG. 3 shows a further embodiment, which, in contrast to the embodiment according to FIG. 1, is designed such that the jet pump 16 is located in the housing 6. In addition, the line 17 extends vertically upwards (with respect to the direction of the force of gravity), so that the opening 21 is oriented towards the top. This opening 21 is therefore provided in an upper region of the housing 6, where hydrogen potentially collects. As a result, the hydrogen collected there can be extracted in a particularly effective way.

FIG. 4 shows a further embodiment, which differs from the variant according to FIG. 2 by the provision of an additional bypass line 25. This bypass line 25 branches off the exhaust line 15 at the branch point 26 upstream of the jet pump 16. The jet pump 16 can be bypassed by means of this bypass line 25. The exhaust gas stream flowing in the exhaust line 15 can therefore at least partially be routed through the bypass line 25 if required. For this purpose, an adjusting element designed as a damper 27 in the illustrated embodiment is adjustable under electronic control. In the illustrated embodiment, the damper 27 is provided directly at the branch point 26 and can be adjusted by means of a servo motor 28. The adjustment may be continuous.

It is preferably provided that a proportion of the exhaust gas stream is discharged in dependence on a fuel concentration in the space 7.

In addition, the variant with the bypass line 25 offers the advantage that during most of the operating time of the fuel cell apparatus 1 the exhaust gas stream flowing from the cathode region 3 can flow along the path of least flow resistance, which is represented by a discharge via the bypass line 25. This is a slightly more effective process with respect to compressor power. By, for example, intermittently operating the damper 27, the exhaust gas stream from the cathode side or the cathode region 3 can repeatedly be routed for short periods via the primary exhaust line 15a and thus via the jet pump 16, so that the medium mixture can be extracted or drawn from the space 7. In the embodiment according to FIG. 4, the jet pump 16, the bypass line 25 and the branch point 26 are located outside the housing 6.

FIG. 5 shows a further embodiment in which, in contrast to the embodiment according to FIG. 4, the branch point 26 and the jet pump 16 as well as a part of the bypass line 25 are located outside the housing 6. In addition, FIG. 5 shows a control unit 29 which is electronically connected to the servo motor 28 and to a device for detecting the fuel concentration in the space 7, in particular to the sensor 30, in a manner suitable for conducting signals or data. Depending on the fuel concentration detected by the sensor 30, the damper 27 can be adjusted as required by the servo motor 28, which can be activated by the logic and/or control unit 29.

If a defined set limit value of fuel concentration is detected, a signal is transmitted to the logic and/or control unit 29. This unit 29 processes the signal and then operates the damper 27 by means of which the path of the exhaust gas stream from the cathode region 3 via the jet pump 16 and thus via the exhaust line 15a can be predetermined, so that the medium mixture can be extracted from the space 7 of the housing 6. The operation of the damper 27 and thus the path of the exhaust gas stream of the cathode region 3 is therefore controlled in dependence on the hydrogen concentration in the space 7. The control of the damper 27 can alternatively be determined by other or further parameters. Such parameters in this context may for example be the air mass flow and the speed of the compressor 13. The fresh air 22 is supplied via the opening 23 in the base of the housing 6.

FIG. 6 shows a further embodiment without any opening 23 in the base of the housing 6, instead of which an opening 31 is provided at a lateral point of the housing 6, this being located vertically below the fuel cell (with respect to the direction of the force of gravity). In this variant, the opening 31 can be closed by means of a closing element 32, the closing element 32 being controlled by the logic and/or control unit 29. The closing element 32 may for example be operated magnetically. This, too, involves a signal- or data-conducting connection as provided between the sensor 30 and the servo motor 28. If a fuel concentration which exceeds a preset limit value is detected in the space 7, the sensor 30 transmits a signal to the unit 29. This processes the signal accordingly and transmits signals to the damper 27 and to the closing element 32, which frees the opening 31. Following a reduction of the fuel concentration in the space 7 of the housing 6 or following a defined period of time, the normal state is re-established by means of the appropriate activation of the damper 27 and the closing element 32. This means that the housing 6 is once again closed as on the one hand the opening 31 is blocked by the closing element 32 while on the other hand the jet pump 16 is bypassed by adjusting the damper 27 to a position in which the exhaust gas stream emerging from the cathode region 3 is completely diverted via the bypass line 25. This closed position of the closing element 32 and the position of the damper 27 in which the exhaust line 15a is blocked are shown in FIG. 6.

FIG. 7 shows an embodiment of the fuel cell apparatus 1 in which, in contrast to the illustration of FIG. 6, the closing element 32 is shown in its open position. In addition, the damper 27 is shown in a state in which the bypass line 25 is blocked completely and the exhaust gas stream emerging from the cathode region 3 is completely routed via the exhaust line 15a and thus via the jet pump 16.

Individual features or combinations of features of a specific embodiment can obviously be combined with features or combinations of features of other variants in order to create yet other embodiments. In addition, features or combinations of features not described in the context of the embodiments should obviously be considered as supplements to the described embodiments.

### LIST OF REFERENCE NUMBERS

1 Fuel cell apparatus
2 Fuel cell
3 Cathode region
4 Anode region
5 PEM
6 Housing
7 Free space
8 Reservoir
9, 11 Supply lines
10, 15 Exhaust lines
12 Air filter
13 Compressor
14 Motor
16 Jet pump
17 Line
18 Element
19 Narrowing
20 Termination
21 Opening
22 Fresh air
23, 31 Openings
24 Catalyst
25 Bypass line
26 Branch point
27 Damper
28 Servo motor
29 Control unit
30 Sensor
32 Closing element

1. A fuel cell apparatus with
at least one fuel cell (2) having an anode region (4) and a cathode region (3) and being accommodated in a housing (6), wherein a flushing medium for flushing the housing (6) can be introduced into a space (7) of the housing (6) outside the fuel cell (2), and
a device (16, 17, 18, 19) for discharging the medium mixture contained in the space (7) and containing the flushing medium, which device is connected to the space (7) and to an exhaust line (15, 15a) leading off the cathode region (3) and designed such that the discharge of the medium mixture is coupled to the exhaust gas stream flowing in the exhaust line (15, 15a) in terms of flow technology.

2. The fuel cell apparatus according to claim 1, wherein the flushing medium is fresh air introduced from the environment.

3. The fuel cell apparatus according to claim 1,
wherein the device (16, 17, 18, 19) is designed such that the exhaust gas stream forms a propulsion jet by means of which the medium mixture can be extracted from the space (7) automatically.

4. The fuel cell apparatus according to claim 1, wherein the device (16, 17, 18, 19) comprises a jet pump (16).

5. The fuel cell apparatus according to claim 1, wherein the device (16, 17, 18, 19) comprises a narrowing (19) with a flow cross-section which is reduced compared to the flow cross-section upstream and downstream of the narrowing (19).

6. The fuel cell apparatus according to claim 5, wherein the device (16, 17, 18, 19) comprises a line (17) terminating into the space (7), which branches off the narrowing (19).

7. The fuel cell apparatus according to claim 6, wherein the opening (21) of the line (17) which terminates into the space (7) is oriented towards the side with respect to the direction of the force of gravity.

8. The fuel cell apparatus according to claim 1, wherein the opening (21) of the line (17) which terminates into the space (7) is oriented towards the top with respect to the direction of the force of gravity.

9. The fuel cell apparatus according to claim 1, wherein the device (16, 17, 18, 19), in particular the line (17), is connected to the housing (6) above the fuel cell (2) with respect to the direction of the force of gravity and terminates into the space (7).

10. The fuel cell apparatus according to claim 1, wherein the housing (6) has an opening (23) for the supply of the flushing medium (22), which is located formed below the fuel cell (2) with respect to the direction of the force of gravity.

11. The fuel cell apparatus according to claim 1, wherein the housing (6) has an opening (31) for the supply of the flushing medium (22), which is located above the fuel cell (2) with respect to the direction of the force of gravity.

12. The fuel cell apparatus according to claim 10, wherein the opening (23, 31) can be closed by an electronically controllable closing element (32).

13. The fuel cell apparatus according to claim 1, wherein the device (16, 17, 18, 19) is completely accommodated within the housing (6).

14. The fuel cell apparatus according to claim 1, wherein a bypass line (25) for bypassing the device (16, 17, 18, 19) branches off the exhaust line (15, 15a) upstream of the device (16, 17, 18, 19).

15. The fuel cell apparatus according to claim 14, wherein the proportions of the exhaust gas stream which flow via the device (16, 17, 18, 19) and via the bypass line (25) are adjustable.

16. The fuel cell apparatus according to claim 15, wherein the proportions are adjustable in dependence on a fuel concentration in the space (7).

17. The fuel cell apparatus according to claim 15, wherein the proportions are adjustable by means of an adjustable, preferably electronically controllable, adjusting element (27).

18. The fuel cell apparatus according to claim 1, further comprising a catalyst (24) through which the medium mixture discharged from the space (7) can be routed.

19. The fuel cell apparatus according to claim 18, wherein the catalyst (24) is located in the line (17) extending between the space (7) and the narrowing (19) of the device (16, 17, 18, 19).

20. The fuel cell apparatus according to claim 1, further comprising a device (22) for detecting the fuel concentration in the space (7) of the housing (6) outside the fuel cell (2).

21. The fuel cell according to claim 20, wherein the device (22) is located within the housing (6) and outside the fuel cell (2).

22. A method for the operation of a fuel cell apparatus (1) with at least one fuel cell (2) having an anode region (4) and a cathode region (3) and being accommodated in a housing (6), the method comprising
introducing a flushing medium for flushing a space (7) of the housing (6) into the housing (6) outside the fuel cell (2), and
extracting the flushing medium from the space (7), wherein an exhaust gas stream flowing in an exhaust line (15, 15a) of the cathode region (3) is coupled to the space (7) in terms of flow technology in such a way by a device (16, 17, 18, 19) that the medium mixture contained in the space (7) and containing the flushing medium is extracted from the space (7).

23. The method according to claim 22, wherein the device (16, 17, 18, 19) is enabled to extract the medium mixture in dependence on a fuel concentration in the space (7).

24. The method according to claim 22, wherein the space (7) is flushed with fresh air (22).

25. The method according to claim 22, wherein the exhaust gas stream emerging from the cathode region (3) is routed as required, preferably in dependence on the fuel concentration in the space (7), via the exhaust line (15, 15a) and/or via a bypass line (25) branching off the exhaust line (15, 15a) upstream of the device (16, 17, 18, 19).
